(19) United States
(12) Patent Application Publication
(10) Pub. No.: US 2015/0308832 A1
(43) Pub. Date: Oct. 29, 2015

(54) METHOD FOR MANAGING THE AIR DATA OF AN AIRCRAFT

(71) Applicant: THALES, Courbevoie (FR)

(72) Inventor: Jacques Coatantiec, Fauconnieres (FR)

(21) Appl. No.: 14/647,429

(22) PCT Filed: Nov. 29, 2013
(86) PCT No.: PCT/EP2013/075145

§ 371 Date: May 26, 2015

(30) Foreign Application Priority Data
Dec. 5, 2012 (FR) 12/03299

(51) Int. Cl. G01C 21/16; G01C 5/06

(52) U.S. Cl. CPC G01C 21/165; G01C 5/06

(57) ABSTRACT

The invention relates to a method for managing altitude data of an aircraft in which a main baro-inertial computation loop is used that uses signals originating from an inertial unit and a standard altitude information item supplied by a main air data reference, and at least one standard altitude information item supplied by a secondary baro-inertial deviation loop respectively using signals from said inertial unit of the main loop and a to standard altitude information item originating from the second air data reference, and a baro-inertial altitude deviation, a vertical speed deviation and accelerometric bias deviation visible on the vertical between the main loop and at least one of said secondary baro-inertial loops are computed.

### BACKGROUND OF THE INVENTION

1. Field of the Invention

The present invention relates to a method for managing hybridized altitude data in the air, in the air domain, or that of “air data”, and in the field of the inertial techniques, for aircraft.

2. Description of the Related Art

In the usual avionics architectures, each inertial unit or inertial reference unit, or each inertial computation part of combined air and inertial parameter units, called ADIRU which stands for “Air Data Inertial Reference Unit”, can be connected to at least two or three air data measurement sources, which each supply it with at least the following data: altitude, standard pressure, computed or calibrated air speed CAS, true air speed TAS and, optionally, the total or impact temperature TAT, and/or the static temperature.

The air speed is the relative speed of the aircraft relative to the air.

Hereinbelow, inertial or baro-inertial path will be used to refer to these computations in the inertial unit or ADIRU and anemometric path will be used to refer to the air data reference or anemometric reference ADR.

Usually, at a given instant, each inertial path uses the measurements from an air data reference ADR to stabilize its vertical path, and notably compute the baro-inertial vertical speed Vzbi and the baro-inertial altitude Zbi. A baro-inertial information item is a hybridization of a barometric information item and an inertial information item, this hybridization having a certain time constant.

The vertical path is generally controlled by a second or third order linear filter with constant gains.

When an anemometric reference ADR is declared invalid or when the airplane system requests an air data reference reconfiguration for a given inertial path it is statutorily necessary to be able to change or switch barometric reference.

At this level, a number of problems can arise:
it is possible that the altitude bias of the new selected barometric reference ADR is significantly different from that of the old reference. This can induce, after switching, oscillations during two to three time constants if precautions are not taken. To avoid them, a decision can be made to reset the baro-inertial altitude to the standard altitude of the new reference. However this poses a problem of integrity. In effect, if the old barometric reference was incorrect (without flagging it) to then it might have corrupted the baro-inertial speed and the vertical bias estimation. In this case, there will once again be oscillations of the baro-inertial loop during two to three time constants. These oscillations can pose a safety problem for the airplane because they can reach high values, notably on the Vzbi;
the above comment shows that it is difficult to be able to revalidate the data of the baro-inertial path after a switch before two to three time constants (typically at least one minute). However, the absence of valid information on the vertical path for a long time (greater than thirty seconds) disrupts the guidance and the flight controls of the airplane.

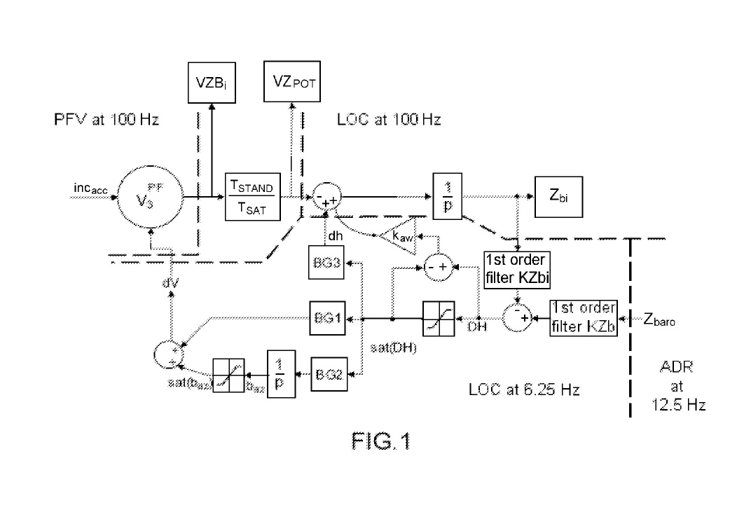

FIG. 1 illustrates a hybridization device between the inertial path and the anemometry (ADR) of a conventional aircraft according to the prior art, and particularly the control.

In the usual avionics architectures, each inertial path can be connected to two or three air data measurement references ADR which each supply it with at least the following data: standard altitude, CAS, TAS and, optionally, the total temperature and the static temperature.

Usually, at a given instant, each inertial path uses the measurements of an air data reference ADR to stabilize its vertical path and notably compute the baro-inertial vertical speed Vzbi and the baro-inertial altitude Zbi.

The vertical path is generally controlled by a second or third order linear filter with constant or pre-computed gains.

The frequencies indicated in the above functional diagram of FIG. 1 are purely indicative and can be modified.

In most usual control systems, the gain Kaw (anti-windup) is zero and the ratio Tstand/Tsat is taken to be equal to 1. Tstand represents the standard temperature corresponding to the measured barometric altitude and Tsat represents the measured static temperature.

The gains BG1, BG2 and BG3 are adjusted to obtain the desired bandwidth for the control system. They can be preprogrammed or computed in real time for example on the basis of a Kalman filter.

The saturations can be present or not.

The reasoning which follows remains applicable regardless of the to configuration retained.

In order to simplify the writing, it will be done with the ratio Tstand/Tsat=1 and without saturations.

In the usual architectures, the air data inertial reference units, or ADIRUs, also called “Inertial Reference Units”, or IRUs, 1 and 2 use different is air data references ADR. If three ADIRUs are used (ADIRU1, ADIRU2, ADIRU3), the ADIRU3 (or IRU3) can use a third reference or else be configured as an ADIRU1 or an ADIRU2.

In most aircraft, and particularly airplanes (and therefore hereinafter in this document) there exist three different air data references (ADR 1, 2 and 3) to which the three ADIRUs (or IRUs) can be connected.

When a reference is declared invalid or when the airplane system (as following a direct action on the part of the pilot or automatically) requests a reconfiguration of air data reference ADR for a given inertial path it is necessary to change or switch barometric reference ADR.

At this level, a number of problems can arise:
it is possible that the altitude bias of the new barometric reference ADR is significantly different from that of the old reference. This can induce, after switching, oscillations during two to three time constants. To avoid them, a decision can be made to reset the baro-inertial altitude to the standard altitude of the new reference. However, this poses a problem of integrity. In effect, if the old barometric reference ADR was incorrect (without flagging it) then it might have corrupted the baro-inertial speed and the vertical bias estimation. In this case, there will once again be oscillations of the loop during two to three time constants.
The above comment shows that it is difficult to be able to revalidate the baro-inertial data after a switch before two to three time constants (or typically at least one minute). However, the absence of valid information on the vertical path for a long duration (>30 seconds) disrupts the guidance and the flight controls of the airplane.

### SUMMARY OF THE INVENTION

One aim of the invention is to mitigate the abovementioned problems.

According to one aspect of the invention, a method is proposed for managing altitude data of an aircraft in which a main baro-inertial computation loop is used that uses signals originating from an inertial unit and a standard altitude information item supplied by a main air data reference, and at least one secondary baro-inertial deviation loop respectively using signals from said inertial unit of the main loop and a standard altitude information item originating from a secondary air data reference, and a baro-inertial altitude deviation, a vertical speed deviation, and an accelerometric bias deviation visible on the vertical between the main loop and at least one of said secondary baro-inertial loops are computed.

It is thus possible to permanently compute a number of baro-inertial solutions and switch over from one to the other without delay by virtue of the computations performed in the deviation loop or loops.

In one embodiment, at least two secondary baro-inertial deviation loops are used that respectively use the signals from said interial unit of the main loop and a standard altitude information item originating from distinct secondary air data references, and said deviations are compared with respective thresholds to detect and possibly isolate an unflagged failed air data reference.

The invention will be better understood on studying a few embodiments described by way of nonlimiting examples and illustrated by the attached drawings in which:

FIG. 1 schematically illustrates an air data device, of the prior art; and

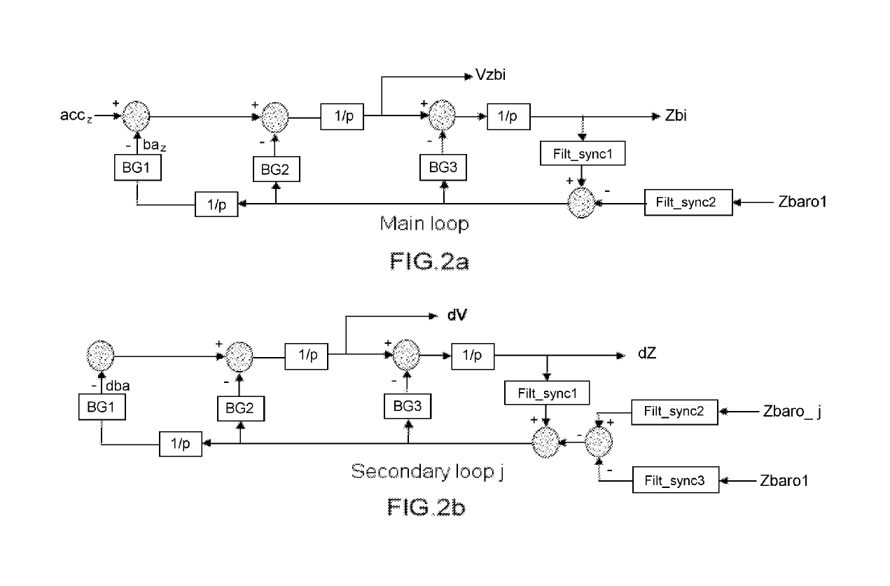

FIGS. 2a and 2b schematically illustrate an air data device, according to one aspect of the invention.

The proposed method makes it possible to avoid the drawbacks described previously. Upon a switch, it makes it possible to immediately revalidate the baro-inertial path with full efficiency and without risk to integrity. It also enables the ADIRU or IRU to monitor the health of the air data reference ADR that it uses and either raise an alert to the pilot or automatically deselect the ADR reference concerned when a problem is detected.

For this it is proposed to keep the usual baro-inertial loop in the ADIRU (or IRU) concerned using the data from the main ADR reference. The is corrections of this filter are applied in closed loop mode to the virtual platform.

In parallel, without adding any virtual platform which would be very costly in terms of computation load, at least one “deviations” loop is computed that makes it possible to compute the baro-inertial altitude deviation, the baro-inertial vertical speed deviation, and the accelerometric bias deviation visible on the vertical, between the loop using the ADR selected by the main loop and a baro-inertial loop path which would use the same UMI and the data from another available ADR reference: example with two secondary loops for three ADRs: one deviation loop on ADR2 and one deviation loop on ADR3. “UMI” denotes the inertial measurement unit.

In these conditions, at the moment when ADR reference is changed, it is possible to perfectly reset the vertical path without delay and to a stabilized and uncorrupted state (i.e. stabilized on a correct value). It is sufficient for this to use the data from the deviation loop concerned to instantaneously correct the data computed by the virtual platform (Zbi, Vzi and estimation of the visible vertical accelerometric bias). Then, the data from the new ADR reference are used as a measurement of the main loop. This process makes it possible to immediately revalidate the data from the baro-inertial loop after the switch because any influence from the old ADR reference is instantaneously eliminated.

Moreover, it is also possible to compute the statistical law that the deviation between the different paths obeys. It will be seen hereinbelow in the description that this deviation depends only on the errors of each air data path and is not influenced for example by deviations induced by atmospheric disturbances (deviation relative to a standard atmosphere) which occurs commonly on the different air data references. This method therefore also makes it possible to detect if an ADR path abnormally disturbs the baro-inertial path. If three ADR references are available, in the case of inconsistency of one ADR reference with the other two, the proposed method also makes it possible to identify the failed reference.

The principle used for the computations is as follows:
the indices 1 represent the data from the baro-inertial path 1
the indices 2 represent the data from the baro-inertial path 2
the indices 3 represent the data from the baro-inertial path 3.
   The computations performed in each of the paths are as follows:
   In the cycle of activation of the baro-inertial filter of period DTB

DH1=Zbi1−Zbaro1

dh1=BG3.DH1

baz1=baz1+BG1.DH1.DTB

dV1=baz1+BG1.DH1

In the virtual platform PFV computations:

Vz1=Vz1+B.acc+(g−dV1)DTP,

B is the attitude matrix,
acc: the acceleration increments

Zbi1=Zbi1−(Vz1−dh1)DTP

If a hybridization was performed on the vertical path with ADR2, the following would apply:

DH2=Zbi2−Zbaro2

dh2=BG3.DH2

baz2=baz2+BG1.DH2.DTB

dV2=baz2+BG1.DH2

In the virtual platform PFV computations:

Vz2=Vz2+B.acc+(g−dV2)DTP,

(B represents the attitude matrix, and acc represents the acceleration increments)

Zbi2=Zbi2−(Vz2−dh2)DTP

By calculating the difference term-by-term the following is obtained:

(dh2−dh1)=BG3(DH2−DH1)=BG3[(Zbi2−Zbi1)−(Zb2−Zb1)]

(baz2−baz1)=(baz2−baz1)+BG2(DH2−DH1).DTB

dV2−dV1=(baz2−baz1)+BG1(DH2−DH1)

(Zbi2−Zbi1)=(Zbi2−Zbi1)−[Vz2−Vz1−(dh2−dh1)]

Vz2−Vz1=(Vz2−Vz1)−(dV2−dV1)DTP

The following are noted:

dz=(Zbi2−Zbi1)

dzbaro=(Zbaro2−Zbaro1)

dVz=(Vz2−Vz1)

dh=(dh2−dh1)

dba=(baz2−baz1)

dV=dV2−dV1

The system of deviation equations can then be written:
Computations to be performed at the frequency of the baro-inertial filter

dh=BG3(dz−dzbaro)

dba=dba+BG2.DTB(dz−dzbaro)

dV=dba+BG1(dz−dzbaro)

Computations to be performed at the PFV frequency:

dz=dz−[dVz−dh]DTP

dVz=dVz+dV.DTP

The deviation loop uses as input, or measures, the standard altitude deviation between the ADR reference Zbaro1 and the secondary ADR reference Z baro_j.
For an airliner, the asynchronomism between the barometric references (typically 60 ms) at a vertical speed of 20 m/s induces only an error of a few feet (ft) which remains negligible.
At the cost of a modest computation load, it is therefore possible to switch from one loop to the other by using the duly computed deviation values.
It will be noted that if the saturation is triggered on the main path, it will be sufficient, to take it into account, in the deviation filter, to compute dzbaro with a saturated value of Zbaro1.
As soon as two barometric references have been available for approximately 100 seconds it is possible to switch from the current loop to a loop converged on the other ADR reference by immediately eliminating the error possibly induced by the reference used before the switch. It is sufficient for this to use the results of the deviation loop.
This computation must be undertaken for the two secondary references.

FIGS. 2a and 2b illustrate the schematic diagram of the main loop using the standard altitude Zbaro1 and a deviation loop based on the use of a standard altitude deviation between the main ADR reference and a secondary ADR reference, i.e. (Zbaro1−Zbaro_j) (j can have the value 2 or 3 in our particular case).
In the figures p represents the Laplace variable.
The Filt sync boxes represent the filtering implemented to resynchronize the standard altitude data.
These two or three loops (one main, and one or two secondaries or “deviation”) run permanently in each ADIRU (or IRU). When there is a switchover, the deviation loop concerned is used to correct the virtual platform at the moment of the reference switch.

Moreover, with the system of deviation equations being linear and depending only on the deviation between the measurements of the baro-altimeters (bias+effect of the static source error corrections, or SSEC, depending notably on the CAS) it is possible to compute the co-variance of the data: baro-inertial altitude deviation, baro-inertial speed deviation, and visible vertical accelerometric bias deviation. The error of the barometric path is modeled as a stable bias over the convergence time of the filter (i.e. approximately 100 seconds).

The state vector to be retained is as follows:

X=(dz,dVz,dh,dba,dV,dzbaro)

The writing of dX/dt is immediate based on the equations written previously:

### There are:

d(dz)/dt=dV−dh

d(dVz)/dt=dV

d(dh)/dt=0

d(dba)/dt=0

d(dV)/dt=dba

d(dzbaro)=0

The propagation and the realignment of the variance/co-variance matrix associated with the defined realignment gains BG1, BG2 and BG3 are then written.

This computation makes it possible to extract the standard deviations expected for dz and dVz.

By multiplying the standard deviation by a co-efficient that is a function of a false alarm rate sought (for example 4.42 for a false alarm rate of 10-5), the threshold is obtained to which the observed values of dz and dVz can be compared.

When the observed deviation dz or dVz becomes unacceptable with respect to the statistics of the deviations, there is a means available for detecting a failed ADR reference and for isolating it if there are three references available.

This information will be able to be usefully exploited by the to airplane system.

The present invention can be applied to ADIRS systems, using in particular an ADIRU, or just an IRS.

The invention makes it possible:
is to switch from one reference to the other without transient (no need to await the convergence of the loop by using the new reference)
with immediate full efficiency: the switch is to a converged baro-inertial loop;
the effects of the use of the old reference are immediately eliminated; and
to monitor the state of operation of the two or three ADR references continually, through the manifestation on the (baro-inertial) outputs used by the avionics system.

There are one or two (even more) deviation loops using the ADR paths other than that concerned (main) running in parallel in each ADIRU (or IRU). This secondary loop or these secondary loops makes/make it possible to change path smoothly.

1. A method for managing altitude data of an aircraft in which a main baro-inertial computation loop is used that uses signals originating from an inertial unit and a standard altitude information item supplied by a main air data reference, and at least one secondary baro-inertial deviation loop respectively using signals from said inertial unit of the main loop and a standard altitude information item originating from a secondary air data reference, and a baro-inertial altitude deviation, a vertical speed deviation and an accelerometric bias deviation visible on the vertical between the main loop and at least one secondary baro-inertial loop is computed.

2. The method as claimed in claim 1, wherein at least two secondary baro-inertial deviation loops are used that respectively use the signals from said inertial unit of the main loop and a standard altitude information item originating from distinct secondary air data references, and said deviations are compared with respective thresholds to detect and possibly isolate an unflagged failed air data reference.
